(19) United States
(12) Patent Application Publication
(10) Pub. No.: US 2020/0141758 A1
(43) Pub. Date: May 7, 2020

(54) Method of optimisation of transport routes according to weather conditions

(71) Applicant: Sergio Escama Sanchez, Madrid (ES)

(72) Inventor: Sergio Escama Sanchez, Madrid (ES)

(21) Appl. No.: 16/182,645

(22) Filed: Nov. 7, 2018

(51) Int. Cl. G01C 21/36; G06F 17/30; G01C 21/34

(52) U.S. Cl. CPC G01C 21/3691; G06F 17/30241; G01C 21/3492; G01C 21/3453; G01C 21/3469

(57) ABSTRACT

This invention describes a method that determines in a comfortable and simple manner the daily routes affected and those predicted to be by adverse weather phenomena and that can be included in an application that calculates and visualised the alternative routes with their derived costs (operation time, economic savings and energy savings). The method will calculate and show the optimal route (between the selected origin and destination) according to the following: The most efficient route with respect to economics, the environment and time. If the cited variables enter into conflict, the tool will show the most economically efficient route and/or the most environmentally efficient one and/or the most efficient in time, and furthermore, the interrelations among these variables.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT INCORPORATION-BY-REFERENCE OF MATERIAL SUBMITTED ON A COMPACT DISC

Not Applicable

### BACKGROUND OF THE INVENTION TECHNICAL FIELD

### Field of the Invention

Route optimisation is always a problem in our society; the growth of the cities has increased considerably in recent decades, making the public transport routes existing up to now insufficient. In view of the appearance new urban nuclei, the city councils must change or add new routes to their public transport services in conditions of sustainability and budgets, which is not always a simple task.

### Description of Related Art

In the state of the art there are diverse methods of obtaining algorithms that optimise the transport routes, in particular the use of genetic algorithms has been used in recent decades as the solution to these problems. Genetic algorithms are evolving algorithms that are inspired by the principle of natural selection, and genetics can influence it. This type of algorithms simulates the evolution of an initial population throughout various generations to obtain the best individuals. Due to their nature, the genetic algorithms are appropriate for solving complex optimisation problems that have a large number of factors.

The request for American patent US 20110208419 provides visibility to envisaged future traffic situations, which are based on all the routes reserved in a system at a given point of time. This allows the city planners, for example, to know where the traffic will be in order to adjust the resulting traffic flow. The additional value comes into play by being able to calculate and publish aggregated savings from using this system, such as the driving time, the mileage and fuel. This information can be aggregated to a database and made available to people through their GPS. In a typical implementation, a request for a route is received from a petitioner. Based on the request, an optimised route and a potential position of the petitioner are determined within the optimised route and then it is proposed to the petitioner. The petitioner can select an option of the proposal.

The American patent U.S. Pat. No. 9,207,089 shows a method implemented by a processor, a system and/or a computer program product that guides disabled pedestrians. The mobile tracking readings are received from multiple mobility assistance devices, each one of which has a fixed monitoring device. Based on these mobile tracking readings, multiple pedestrian routes are generated for pedestrians with mobility impediments, which include an optimal pedestrian route that has the highest tracking history for a desired destination.

The International American patent WO/2007/066866 provides a method for routing optimisation on a nested mobile network and a computer-readable recording medium recording a program that uses it. The method includes the steps of: a) the interactive transmission of a routing optimisation message that includes a network prefix of an internal interface at each mobile router on the nested mobile network; b) creation/updating a forwarding table based on the transmitted routing optimisation message; and c) when a mobile router (MR) transmits a received packet, comparison a destination Internet Protocol (IP) address of the packet with the entry of the forwarding table and forwarding the packet to a corresponding interface based on information of the forwarding table.

This invention describes a method that, comfortably and simply, determines the daily routes affected and those predicted by adverse weather phenomena, and that can be included in an application that calculates and visualises alternative routes with their derived costs (time of operation, economic savings, and energy savings). According to the weather data that it obtains, this method catalogues the feasibility of the different routes due to the impact thereof and what the weather models may predict. Therefore, thresholds of warnings will be established for the different weather variables for the transport activity.

The method described in this invention allows predicting the ideal routes in the case the roads have or foresee complicated weather conditions for driving. The method allows the user to have sufficient data to make the best decision (choose an alternative route, stop the truck, wait for weather conditions to improve, etc.).

One of the objectives of this invention is to minimise the impact that the adverse weather conditions may cause in carrying out the transport activity.

Another of the purposes of the invention is the direct calculation of the energy, time and environmental cost of the commercial activities.

Additionally another purpose of the invention is to optimise the management of commercial routes from the viewpoint of energy, environment and time, seeking alternatives to the traditional routes and quantifying the impact that the weather conditions may impose on the transport routes.

In addition, the method will be capable of calculating the economic cost, the time in executing the specific service and the amount of CO2 released on the commercial routes.

In summary:

It intends to carry out a TMS (Transport Management System) application with the following objectives:

Predictive: predict the future in order to know how to act.

Preventive: get ahead of the “undesired” weather events.

Productive of added values: innovative, pioneer and useful.

Cost optimising: efficiency and energy savings.

### BRIEF SUMMARY OF THE INVENTION

This invention reveals a method for the solution of TMS (Transportation Management Systems), which considers weather variables in the prediction of transport routes and which allows optimizing costs, regarding economic aspects, time and the environment; that is, it provides the best information possible so that the final manager may make the most appropriate logistical decision.

### BRIEF DESCRIPTION OF THE DRAWINGS

To supplement the description that is being made and for the purpose of aiding a better understanding of the characteristics of the invention, in accordance with a preferred example of the practical realisation thereof, a set of drawings are included as an integral part of this description, where as an example but not limited to it, the following has been represented:

FIG. 1 shows the scale of colours depending on the adverse weather variable, vulnerable to road transport.

### DETAILED DESCRIPTION OF THE INVENTION

This invention presents a method that develops an application for the solution of TMS (Transportation Management Systems) adding different type of layers, among them, weather, in order to create a preventive, predictive and cost-optimising tool, regarding economic aspects, time and the environment; that is, it provides the best information possible so that the final manager or client may make the most appropriate decision for the benefit of his company. In addition, it allows minimising the impact that adverse weather conditions may cause on carrying out the transport activity, it directly calculates the energy, time and environmental cost of the commercial activities and it optimises the management of commercial routes from the viewpoint of energy, environment and time, seeking alternatives to the traditional routes and quantifying the impact that the weather conditions may impose on the transport routes.

The method can be introduced in an application where the user can visualise comfortably and simply the affected roadway routes and those foreseen by adverse weather phenomena and where the system may calculate and visualise the alternative routes with their derived costs (operation time, economic savings and energy savings).

The application will be capable of calculating the economic cost, the time spent in executing the specific service and the amount of CO2 released on the commercial routes.

### Description of the Preferred Embodiment

This invention describes a method which, to be used, requires some general data entry, and after applying the necessary equations, it obtains the most optimal routes considering the weather conditions, in such a way that it allows us at least to know, based on these conditions, the result in duration of the route (T), the economic cost (G) and the amount of [CO2] released.

The method to include in the application will consist of the following data:

### Entry Data:

Date and time of the prediction, origin and destination

### Vehicle Data:

Load, Specific fuel consumption, Air density, Rolling resistance coefficient, Air resistance coefficient; Maximum cross-section, Average speed and type of driving, CO2 emission factor, Average consumption of the vehicle.
Fuel price.

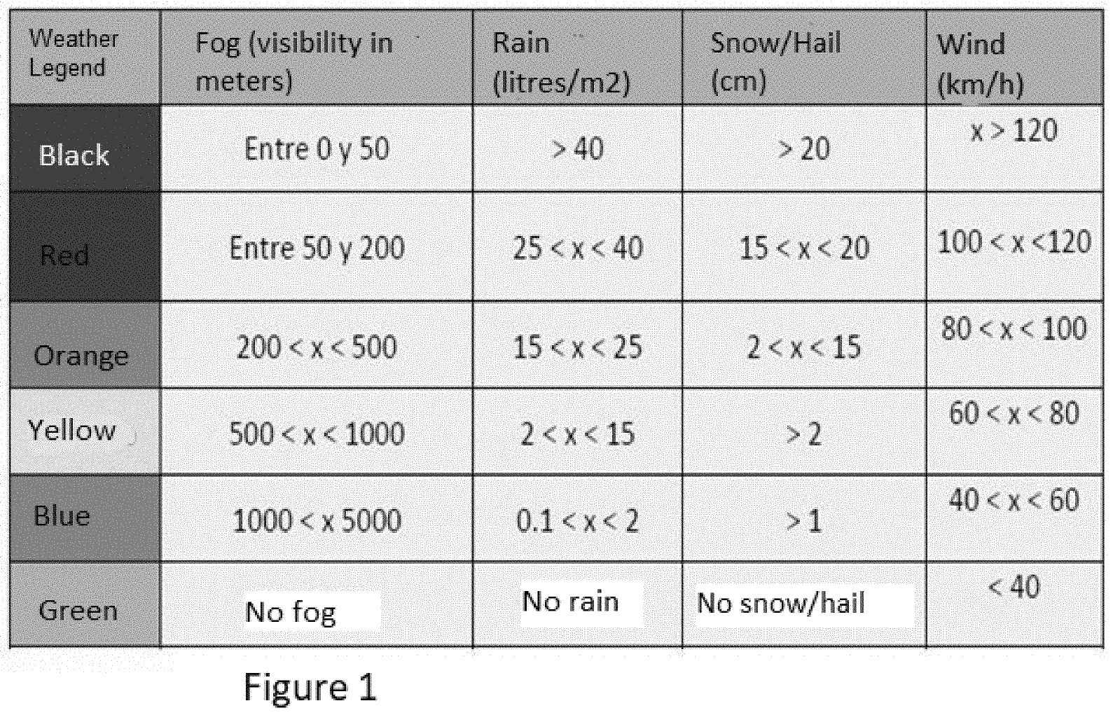

Results obtained by applying the method:
Estimated duration without weather impact (hours, minutes and seconds).
Weather impact (hours, minutes and seconds).
Total duration with weather impact (hours, minutes and seconds).
Economic cost (€).
Environmental repercussion ([kg of CO2 released]).
Weather data at outset; per road section; a scale of colours will be applied, depending on the adverse weather variable, vulnerable to road transport, for example, the limits shown in FIG. 1 could be proposed.

As for the prediction of adverse weather conditions; the following probability of appearance of phenomena directly affecting driving will be taken into account:
Forecast of fog and visibility.
Forecast of wind intensity.
Forecast of rain and/or drizzle.
Forecast of snow and hail.

The method will calculate and indicate the optimal route (between the origin and the selected destination) according to the following:
The most efficient route, economically, environmentally and with respect to time.
If the above variables enter into conflict, the tool will show either the most economically efficient route and/or the most environmentally efficient route and/or the most efficient route time-wise, and furthermore, the interrelations between these variables.

The direct calculation of vehicle consumption can be done with the following equation:

Cm=∫Ce×1/nμ[(m×f×g×cos α+ρ/2×cw×At×(V+V0)2)+m(a+g×sen α)]×vdt/∫v.dt

where:
CM: Consumption per route (l/100 Km)
Ce: Specific fuel consumption (l/KwH). Manufacturer's datum.
nμ: Efficiency in the transmission of the drivetrain (dimensionless). Less than 1. Motor specifications.
m: mass of the vehicle (Kg).
f: Rolling resistance coefficient (dimensionless).
g: Acceleration of gravity (m/s2).

### α: Slope (°).

ρ: Air density (kg/m3).
Cw: Air resistance coefficient (dimensionless). From 0.8 to 1.5 in trucks.
At: Maximum cross-section of the vehicle (m2).
V: Driving speed (m/s).
V0: Wind velocity (m/s).
a: Acceleration (m/s2).

### t: Time (s).

This equation presents a first component that intervenes in the rolling resistance and the aerodynamic resistance which is [(m×f×g×cos α+ρ/2×cw×At×(V+V0)2] and a second component that intervenes in the resistance to the acceleration and the resistance to the slope which is m (a+g×sen α)×v.

In the equation there are variables that depend exclusively on mechanics; therefore, they are data that must be included in the vehicle's technical sheet or be provided by the manufacturer:

Ce: Specific fuel consumption (l/KwH)
nμ: Efficiency of transmission of the drivetrain (dimensionless).
Cw: Air resistance coefficient (dimensionless).
At: Maximum cross-section of the vehicle (m2).

There are other variables that are going to be influenced by the weather conditions, which are the following:

f: Rolling resistance coefficient (dimensionless).
ρ: Air density (kg/m3).
V0: Wind velocity (m/s).

Let's suppose a consumption of Co in which the weather conditions do not have an influence:

Co=∫Ceo×1/nμ[(m×fo×g×cos α+ρo/2×cw×A×v2+m(a+g×sen α)+Br]×v dt/∫v.dt

vo=0. No wind.
Ceo=specific consumption of the motor without adverse weather conditions.
ρo=Mean air density.
fo=Rolling coefficient; it is the coefficient that takes into account the resistance to the rolling of the tyres in dry conditions (without moisture on the pavement).

Let's now suppose a consumption of Cf with adverse weather conditions:

Cf=∫Cef×1/nμ[(m×ff×g×cos α+ρf/2×cw×A×(v+vo)2)+m(a+g×sen α)+Br]×v dt/∫v.dt

vo=Surface wind.
Cef=Specific consumption of the motor with adverse weather conditions.
Pf=Air density.
ff=Rolling coefficient; it is the coefficient that takes into account the resistance to the rolling of the tyres in wet conditions, due to precipitation.

For the same route of a vehicle with some particular mechanical and physical characteristics (mass, maximum power, mechanical parameters, etc.), the study compares the consumption of the vehicle in favourable weather conditions (good visibility, absence of wind and dry pavement conditions) to adverse weather conditions (fog, wind and presence of precipitation).

### Force and Power of Rolling Resistance to Forward Motion

When a tyre rolls along the surface of the roadway, it is deformed. This causes a force that opposes its movement (it will always be a positive term of opposition), which is directly proportional to the weight of the vehicle:

FRO=f×m×g×cos α (1)

### Where:

m: Vehicle mass
f: Rolling resistance coefficient (dimensionless).
g: Acceleration of gravity (m/s2).

### α: Slope

The power in kilowatts (Kw) by rolling will be:

PRO=FRO×V/3600; where V is the speed of the vehicle in km/h. The rolling power in horsepower (CV) will be:

PRO=3.8×10−4×FRO×V (2)

### Force and Power of Aerodynamic Resistance

When a vehicle advances, it displaces the air that is in front of it and fills the emptiness that it leaves behind. The higher the speed, the greater is the force necessary to carry out this task, that is, in order to overcome the aerodynamic resistance. The aerodynamic resistance depends on the frontal section of the vehicle, the shape of the truck and the density of the air, and it increases with the increment in speed squared.

FL=0.0386×ρ×cw×At×(V+VO)2 (3)

### Where:

ρ: Air density (kg/m3).
Cw: Air resistance coefficient (dimensionless).
At: Maximum cross-section of the vehicle (m2).
V: Driving speed (Km/h).
V0: Wind velocity (Km/h).

The aerodynamic power in kilowatts (Kw) will be:

PL=FL×V/3600; where V is the vehicle speed in Km/h.

The aerodynamic power in horsepower (CV) will be:

PL=3.8×10−4×FL×V (4)

### Force and Power of Resistance to Forward Motion Due to Slope

The force of gravity tends to keep any body from ascending; therefore, when a vehicle ascends a slope, this force is must be overcome. In the same way, when it descends a slope, this same force favours the movement, tending to accelerate the truck. This force depends directly on the total mass of the vehicle and of the inclination of the slope:

FP=m×g×sen α (For flat highway α=0, sen α=0 and Fp=0) (5)

Approximately:

FP=0.01×m×g×ρ (valid for p≤20%) (6)

### Where:

m: Vehicle mass (Kg).
g: Acceleration of gravity (m/s2).
p: slope (%).

The power in kilowatts (Kw) due to the slope will be:

PP=FP×V/360000 where V is the vehicle speed in Km/h. (7)

The resistance power to the forward motion due to the slope in horsepower (CV) will be:

PP=3.8×10−6×FP×V (8)

It does not depend on the weather conditions.

### Force and Power of Resistance Due to Acceleration

When a vehicle accelerates, it needs to overcome a force proportional to the mass of the vehicle due to acceleration to which it is subjected. Therefore, in a process of acceleration, the greater the intended acceleration or the greater the mass of the vehicle, the greater the traction forces has to be in the wheel:

FA=m×a (9)

Where:

m: Vehicle mass (Kg).
a: Acceleration (m/s2).

The power in kilowatts (Kw) due to the slope will be:

PA=FA×V/3600 (where V is the vehicle speed in Km/h. (10)

The power of resistance due to acceleration in horsepower (CV) will be:

PL=3.8×10−4×FL×V (11)

It does not depend on weather conditions.

Total force and power to the motion. Consumption

The resistance to motion in Newtons will be:

FT=FRo+FL+FP+FA (12)

The total power for motion in Kw will be:

PT=PRo+PL+PP+PA (13)

The mean consumption of the vehicle consists of overcoming this resistance to motion, therefore:

CM=Ce×PT/nμ×V (14)

If nμ≈0.082, the CM in l/100 Km will be:

CM=0.09×Ce×PT/V, taking into account each of the terms of PT: CM=(0.09×Ce/V)×(PRo+PL+PP+PA) and breaking down each term:

CM=CRo+CL+CP+CA (15)

Of the four terms that affect the vehicle's fuel consumption the first two are those that depend on the weather conditions.

The mean consumption of a truck is directly proportional to the rolling resistance and to the aerodynamic resistance, with the latter being directly proportional to the addition of the truck's speed and to that of the wind squared.

### Repercussion of Weather Conditions on Consumption

Influence on the weather conditions due to FRo.

In the path of the vehicle, the wheels in their movement can contact the pavement in dry conditions (dry asphalt) or in wet conditions (wet asphalt due to precipitation).

### With Dry Asphalt:

FRO=f×m×g×cos α; con f=rolling coefficient; the coefficient that takes into account the rolling resistance of the tyres in dry conditions (without moisture on the pavement).

### With the Asphalt Wet:

F′RO=f′×m×g×cos α; con f′=rolling coefficient; the coefficient that takes into account the rolling resistance of the tyres in wet conditions, due to precipitation.

According to a study made by the Technical University of Gdansk and the School of Mechanics of Gdansk (Poland) and by the National Institute of Transport Research in Linkoping (Sweden), they have been able to reach the conclusion that the moisture and precipitation have a strong impact on the increase of the rolling coefficient, directly impacting the increase of consumption and therefore in the release of polluting gases and of CO2.

According to this study, the increase in fuel expense directly related to the rolling resistance depends on:
The type of tyres.
The type of pavement.
The intensity of the precipitation.
Vehicle speed.
With adverse weather conditions (precipitation on the pavement) the increase of f is between 10% and 50%
The increment off is greater at higher speeds (V>50 Km/h).
At low speeds (V<50 Km/h), even thin layers of water film (0.1 mm in height) has considerable effects on f.

We see below the ratio between the PRo (dry conditions) and the P′Ro (wet conditions):

P′RO/PRO=ff×V′/fo×V (16)

Where V is the vehicle speed in the route with dry pavement. Where V′ is the vehicle speed in the route with wet pavement. If the speed of both situations is the same:

P′RO/PRO=ff/fo (17)

Then, the ratio between consumption in dry conditions CRo and in wet conditions C′Ro will be:

C′RO/CRO=ff/fo (18)

since at the same speed, the power required of the motor will be identical and the consumptions Ce y Ce will be the same.

That is, the increase in consumption is directly proportional to the change off.

If the speed in both situation is not the same:

P′RO/PRO=ff×V′/fo×V

Then the ratio between consumption in dry conditions CRo and in wet conditions C′Ro will be:

C′RO/CRO=ff×C′e/fo×Ce (19)

We observe that consumption does not depend directly on the V in the equation.

In contrast, for different speeds, the power required of the motor will be different and the consumption Ce and Ce will not be identical, even more so the greater the difference is between V and V′.

Let's suppose a reduction in speed of 10% (V′=0.9V) and an increase of f of 10% (ff=1.1fo), then:

C′RO/CRO=ff×C′e/fo×Ce=1.11×C′e/Ce

At lesser speeds, the necessary power will be less but the performance of the specific consumption will depend on the driving style (efficient driving is always advisable), since at high revolutions (lower gears) it will increase and at lower revolutions (higher gears) it will decrease. At any rate, for a small change in speed, the specific speed will be similar both in one case and in the other (the difference will increase if the change in speed is evident, in an extreme case it would be around 15% (consult equiconsumption curves—IDAE (Institute for Energy Diversification and Saving)), and therefore:

C′Ro/CRo=1.11 (increase in rolling consumption of approximately 10%)

Consequently, in conditions of precipitation on the roadway, driving at speeds higher than lower ones saves fuel due to the specific consumption.

But safety and the reaction time to unexpected events decrease. If operational security is prioritised, driving at lower speeds increases consumption and also the total time of the operation (in contrast, as we will see with the aerodynamic resistance, the low speeds contribute to a lower resistance).

To correctly quantify the penalisation due to the specific consumptions, one would have to consult the equiconsumption in the technical sheet or the manufacturer of each truck.

### Influence of the Weather Conditions Due to FL

Logically, a headwind increases consumption and a tailwind decreases it (to a lesser extent, the headwind and side wind cause increases in consumption).

Let's suppose that the wind speed is zero; Vo=0 and therefore:

With PL=FL×VyPL=0.386×ρ×cw×At×V3/3600 (20)

Duplicating the speed equals multiplying by eight the power necessary to overcome the aerodynamic resistance. Therefore, the components that modify the aerodynamics of the vehicle take on great importance, for which reason smooth shapes, without brusque alterations of section or angular areas are recommended.

If the wind speed is not zero, we will have:

With PL=FL×VyFL=0.386×ρ×cw×At×(V+VoVO)2×V/3600 (21)

The density of the air depends on the temperature and to a lesser measure the pressure, for each exterior T of the air, the density takes a different value. Between −100 C and 350 C, the change is around 15%.

But it is the speed of the vehicle and of the wind that notably influence the power that has to be supplied to overcome the resistance.

Therefore, the ratio between consumption in conditions without wind CL and in conditions with wind C′L it will be:

C′L/CL=μL×C′e×(V′+Vo)2/ρO×Ce×V2 (22)

### Where:

ρO=Air density at a Temperature To
μL=Air density at a Temperature TL
V=Vehicle speed in the case without wind.
Vo=Wind velocity.
V′=Vehicle speed in the case with wind.

As with the case of the rolling resistance, for different speeds of movement, the power required by the engine will be different and the consumptions Ce and Ce will not be identical; the greater the difference is between V and V′. Nonetheless, according to the equiconsumption curves (relation between P,V and Ce) the specific consumption will be similar, especially when speaking of power and speeds over 20 km/h.

Therefore, taking into account the above:

C′L/CL=(V′+VO)2/V2 (23)

If the speed in both situations is the same (V′=V):

C′L/CL=1+2×Vo/V+V2/V2 (24)

### For V>>Vo C′L/CL≈1

### For V=VO C′L/CL=4

For any other value of V and of VO, C′L/CL will be between 1 and 4.

Therefore, the consumption will be quadrupled when the vehicle speed equals the direct headwind speed.

As Vo increases, the ratio of consumption increases. As V=V′ decreases, for the same wind velocity Vo, the consumption of C′L increases considerably with respect to CL, even more so the higher the wind velocity.

If the velocity in both situations is not the same (V′≠V):

C′L/CL=V′2+2×V′×Vo+V2/V2 (25)

In these circumstances, the weather penalisation is hard to quantify, since the consumption with wind with respect to without it depends on three variables (V′,Vo,V) and of all its ratios. In general, as the speed of Vo increases, independently of the other speeds, consumption increases.

As in the previous case, the term in bold will be + or − depending on the direction of the wind with respect to the movement of the truck. The ratio of consumptions will be affected in increments or decreases due to this term.

On the other hand, the wind velocity can impact in different ways the route of the vehicle on the roadway, in such a way that there will be sections of the route where the wind is an obstacle to the forward motion and in other occasions, although to a lesser measure, it collaborates with the movement. In addition, as the routes of the roadway are not straight lines, but rather the layout is irregular, the wind does not always impact directly or against the movement; thus an improvement would be to consider that during the route, on average, the wind impacts with an angle of 45° with respect to the movement:

Vo′2=Vo2×cos(45o) (26)

The best way to quantify the consumption would be to introduce in the equation (25) the wind velocities at the outset of the weather models (for each section); consider if the wind is be an obstacle or help the movement and quantify it statistically considering the equation (26) and making a total estimate of the route.

In any event, as a summary, according to the Institute for Energy Diversification and Saving (IDAE), in its guide to efficient driving of industrial vehicles, it comments that the wind increases consumption up to 8% with winds of around 20 km/h and up to 18% with velocities of 40 km/h (considering that the vehicles has deflectors in the cabin, if not, the consumption can be increased between 18% and 28%, respectively).

As in the case of the rolling resistance, in order to quantify correctly the penalisation due to the specific consumptions, one has to consult the technical sheet or the manufacturer for the equiconsumption curves of each truck.

The consumption of a vehicle on a specific route with some particular characteristics and without adverse weather conditions will be:

CM=CRo+CL+CP+CA (27)

The consumption of a vehicle on the same specific route as above, with identical particular characteristics and with adverse weather conditions will be:

C′M=C′Ro+C′L+C′P+C′A (28)

The ratio between them is:

C′M/CM=C′Ro+C′L+C′P+C′A/CRo+CL+CP+CA (29)

One has to take into account that C′P=CP and C′A=CA since they do not depend on the weather conditions; therefore:

C′M/CM=C′Ro+C′L+CP+CA/CRo+CL+CP+CA (30)

If we suppose that the trajectory is flat and is done at V=cte:

C′M/CM=C′Ro+C′L/CRo+CL

CM=CM[(C′Ro+C′L/CRo+CL)] (31)

Therefore,

C′M≥CM (32)

Since C′Ro≥CRo and C′L≥CL.

In view of the above result, it can be verified that the adverse weather conditions provoke delays and increases in consumption.

The method of this invention includes the following operative stages:
Entering the following data:
   a) Date and time of the prediction,
   b) Origin and destination of the route,
   c) Load (m), Specific fuel consumption (Ce), specific consumption in wet conditions (C′e), Air density (ρ), Air resistance coefficient (Cw), Maximum cross-section (At), Average speed and driving type (V), Gas emission factor (F);
   d) Rolling resistance coefficient of the tyres in dry conditions (fO); Rolling coefficient of the tyres in wet conditions (ff); Fuel price (pc).
   d) Determining with these data: the force (FRo) and power (PRo) of rolling resistance to forward movement; force FL) and power (PL) of aerodynamic resistance; force (FP) and power (PP) of resistance to advancing on a slope; force (FA) and power (PA) of acceleration resistance; total force (FT) and power (PT) in moving; and the mean consumption (CM) of the vehicle.
   e) Determining the values for weather conditions for the power (P′RO)), and the consumption of the vehicle due to the force of rolling resistance to forward movement (C′RO) and consumption of the vehicle (C′L) due to the aerodynamic resistance; and
   f) Determining the time it will take for the route (T), the economic expense (G) and the amount of released [CO2].

The method described in this invention allows determining the ideal route under adverse weather conditions. The optimisation of the transport according to the weather conditions contributes to the objectives of the company as follows: an increase in safety of the merchandise and of the vehicle in the transport. It allows knowing the current weather conditions and the predictions, it minimises the impact on material losses that the load or the vehicle itself may suffer, having an impact on the company's profit and what is more important, it lessens the personal injuries to the professionals in charge of providing the different services and to the travellers in general.

Efficient management of fuel and of the fleet by means of: real and updated monitoring of the transport activities. Constant support for all the logistic activities of the transport by means of visualisation of the company's transport in the meteorological panorama at every moment.

Knowing all the weather variables brings about a savings in fuel by varying, planning, delaying, cancelling, advancing or redesigning the routes according to the current and predicted weather conditions.
A temperature control according to the existing meteorological conditions.

It impacts the maintenance of the cold chain in the refrigerator trucks.
Estimates of the economic cost, time and/or environmental impact of the operations.

By being included in a corresponding app, the method will allow knowing, before carrying out the operations, the most economically efficient routes and knowing the amount of CO2 released to the atmosphere, as well as the total duration of the activity. Therefore, the software tool will be capable of quantifying the economic and environmental cost that the travel supposes of the vehicles on the usual routes and/or alternatives in view of the adverse weather phenomena. Likewise, the data can be stored in order to subsequently make a temporary assessment of the costs.

Fuel management includes the design and putting into practice of a control, supervising and tracking system of global and individualised fuel consumption of the vehicles of a transport fleet. Fuel management allows taking advantage in the most profitable way each litre of fuel acquired, contributing with this not only to the economy of the company, but also to energy saving and to the improvement of the preservation of the environment.

An adequate fuel management according to weather and climate conditions entails an adequate planning of routes and vehicles according to the particular weather in each area, besides allowing the use of efficient driving techniques, in view of adverse weather phenomena and a correct maintenance of the vehicles, in view of external weather determinants.

1- A method to optimise the transport routes according to weather data, which consists of entering the following data:
a) Date and time of the prediction,
b) Origin and destination of the route,
c) Vehicle data: Load (m), Specific fuel consumption (Ce), Specific consumption in wet conditions (C′e), Air density (ρ); Air resistance coefficient (Cw); Maximum cross-section (At); Average speed and driving type (V); Gas emission factor (F); Rolling resistance coefficient of the tyres in dry conditions (fO); Rolling resistance coefficient of the tyres in wet conditions (ff); Precio del combustible (pc);
d) Determining with these data the force (FRo) and power (PRo) of rolling resistance to forward movement; force (FL) and power (PL) of aerodynamic resistance; force (FP) and power (PP) of resistance to advancing on a slope; force (FA) and power (PA) of acceleration resistance; total force (FT) and power (PT of movement; and the mean consumption (CM) of the vehicle.
e) Determining the values for weather conditions for the power (P′RO), and the consumption of the vehicle due to the force of rolling resistance to forward movement (C′RO) and consumption of the vehicle (C′L) due to the aerodynamic resistance; and
f) Determining the time (T) it will take for the route, the economic expense (G) and the amount of released [CO2].

2- The method according to claim 1 where the force of rolling resistance to forward movement FRo is determined by means of the equation FRO=f×m×g×cos α
Where: m: vehicle mass, f: Rolling resistance coefficient (dimensionless), g: acceleration of gravity (m/s2), a: slope.

3- The method according to claims 1 and 2 where the power (PRo) of rolling resistance to forward movement is determined by means of the equation PRO=3.8×10−4×FRO×V where V is the vehicle speed in km/h.

4- The method according to claim 1 where the force (FL) of aerodynamic resistance is determined by means of the equation FL=0.0386×ρ×cw×At×(V+VO)2,
Where: ρ: air density (kg/m3), cw: air resistance coefficient (dimensionless), At: Maximum cross-section of the vehicle (m2), V: driving speed (Km/h), V0: wind velocity (Km/h).

5- The method according to claims 1 and 4 where the power (PL) of aerodynamic resistance is determined by means of the equation PL=3.8×10−4×FL×V.

6- The method according to claim 1 where the force (FP) of resistance to forward movement due to slope is determined by the equation FP=0.01×m×g×p for p≤20% Where: m: vehicle mass (Kg), g: acceleration of gravity (m/s2) and ρ: slope (%).

7- The method according to claims 1 and 6 where the power in KwH is determined by the equation PP=FP×V/360000 where V is the vehicle speed in Km/h.

8- The method according to claim 1 where the force (FA) of resistance to acceleration is determined by means of the equation FA=m×a, where: m: vehicle mass (Kg) and a: acceleration (m/s2).

9- The method according to claims 1 and 9 where the power (PA) of resistance to acceleration in KwH is determined by the equation PA=FA×V/3600, where V is the speed of the vehicle in Km/h.

10- The method according to claims 1, 2, 4, 6 and 8 where the total force (FT) of the motion is determined by means of the equation FT=FRo+FL+FP+FA.

11- The method according to claims 1, 3, 5, 7 and 9 where the total power (PT) of the movement is determined by means of the equation PT=PRo+PL+PP+PA.

12- The method according to claims 1 and 11 where the mean consumption (CM) of the vehicle is determined by means of the equation CM=Ce×PT/nμ×V
Where: nμ≈0.082, speed in Km/h and Ce specific consumption of the vehicle.

13- The method according to claims 1 and 3 where the value of the rolling power due to wet conditions for the power (P′RO) is determined by means of the ratio P′RO/PRO=ff×V′/fo×V, where V is the vehicle speed in the route with dry pavement, V′ is the vehicle speed in the route with wet pavement, fo=rolling coefficient in dry conditions and ff=rolling coefficient in wet conditions.

14- The method according to claims 1 and 3 where the consumption in dry conditions (CRo) is determined by means of the equation CRo=(0.09×Ce/V)×PRo where V is the vehicle speed on the route with dry pavement.

15- The method according to claims 1 and 14 where the value of consumption in wet conditions (C′RO) is determined by means of the ratio C′RO/CRO=ff×C′e/fo×Ce Where Ce is the specific consumption of the vehicle in dry conditions and Ce is the specific consumption in wet conditions.

16- The method according to claim 1 where the ratio between consumption in conditions without wind CL and in conditions with wind CL for speeds over 20 Km/h is determined by means of the ratio: C′L/CL=(V′+VO)2/V2
Where:
V=vehicle speed without wind.
Vo=wind speed.
V′=vehicle speed with wind.

17- The method according to claim 1 where the duration time of the route (T) is determined by means of the equation T=E/V, where E is the distance between the points of the route and V is the average speed of the vehicle.

18- The method according to claims 1, 12 and 16 where the economic expense (G) for travelling the points of the route is determined by means of the equation G=CM×pc×E, Where CM is the average consumption and pc is the price of fuel.

19- The method according to claims 1, 12 and 16 where the amount of [CO2] released in by travelling along the points of the route is determined by means of the equation [CO2]=F×CM×E/100, where F is the gas emission factor and CM is the average consumption.
